(19) United States
(12) Patent Application Publication
(10) Pub. No.: US 2017/0023301 A1
(43) Pub. Date: Jan. 26, 2017

(54) SCREENLESS PANELS FOR A GRAIN DRYER

(71) Applicant: Sukup Manufacturing Co., Sheffield, IA (US)

(72) Inventor: David J. Brownmiller, Mason City, IA (US)

(21) Appl. No.: 14/808,396

(22) Filed: Jul. 24, 2015

(51) Int. Cl. F26B 17/12

(52) U.S. Cl. CPC F26B 17/122

(57) ABSTRACT

A plurality of screenless panels for a grain dryer having a plurality of cut outs to receive forced heated air from a heating system. The panels have a plurality of deflectors attached above the cut outs of the panels such that debris and grain fines is prevented from obstructing airflow. The deflectors have a connecting section and a deflecting section that is bent away from the connecting section along a bend line. The deflectors are connected to the panels by bolts placed through aligned apertures in the panels and deflectors.

### BACKGROUND OF THE INVENTION

This invention is directed toward grain drying and more particularly to a screenless panel used with a cross flow dryer.

Cross flow dryers are well known in the art. These dryers have grain pathways that are formed by perforated panels. Typically the perforations, that are approximately 0.094 inches in diameter, permit heated air to pass through the pathways to dry grain. While useful, the perforated panels tend to restrict air flow and can become covered and plugged with debris and grain fines. As a result, the dryers require cleaning in order to maintain dryer capacity and efficiency. Therefore, a need exists in the art for a device that addresses these deficiencies.

An objective of the present invention is to provide a screenless panel for a grain dryer that reduces or eliminates plugging of debris and grain fines.

A further objective of the present invention is to provide a screenless panel for a grain dryer where it is easier to maintain dryer capacity and efficiency

A still further objective of the present invention is to provide a screenless panel for a grain dryer that reduces maintenance.

These and other objectives, features, or advantages of the invention will become more apparent from the specification, drawings, and claims.

### BRIEF DESCRIPTION OF THE DRAWINGS

FIG. 1 is an perspective view of screenless panels for a grain dryer; and

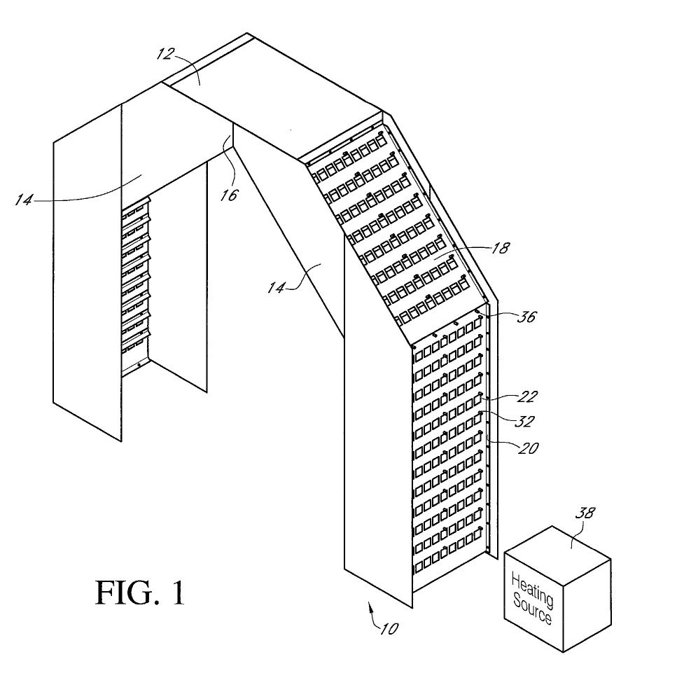

FIG. 2 is an exploded view of screenless panels for a grain dryer

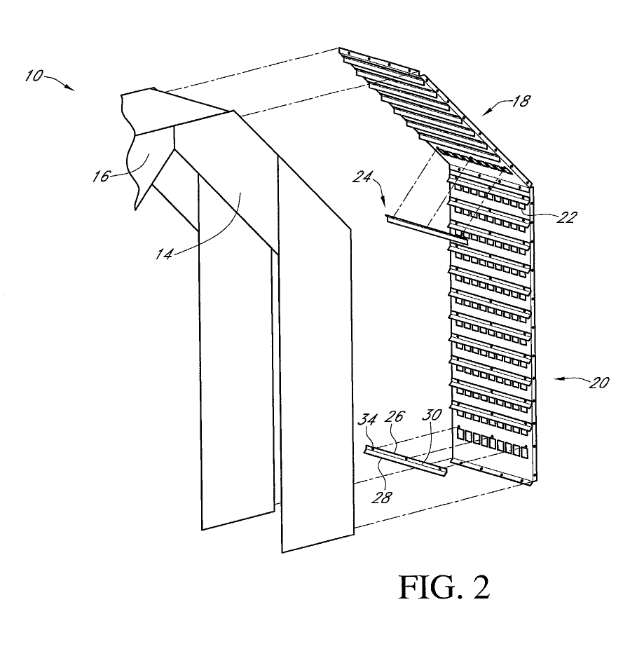

### SUMMARY OF THE INVENTION

A plurality of screenless panels for a grain dryer having a plurality of cut outs to receive forced heated air from a heating system. The panels have a plurality of deflectors attached above the cut outs of the panels such that debris and grain fines is prevented from obstructing airflow. The deflectors have a connecting section and a deflecting section that is bent away from the connecting section along a bend line. The deflectors are connected to the panels by bolts placed through aligned apertures in the panels and deflectors.

### DETAILED DESCRIPTION

Referring to the Figures, a grain dryer 10 has a grain intake 12 that feeds grain into a pair of pathways 14 that form a central dryer chamber or plenum 16. The pathways 14 are formed, in part, by inner and outer panels 18 and 20. The panels 18 and 20 have a plurality of cutouts 22 that preferably are aligned and square, but can be positioned in any manner and in any size and shape.

Attached to panels 18 and 20 within the pathway 14 are a plurality of deflectors 24. The deflectors 24 are preferably elongated having a connecting section 26 and a deflecting section 28. The deflecting section 28 is bent in relation to the connecting section 26 along bend line 30. Preferably the deflecting section 28 is bent at a thirty degree angle in relation to the connecting section 26.

The connecting section 26 have a plurality of apertures 32 that align with apertures 34 in panels 18 and 20. Bolts 36 are received within apertures 32 and 34 to secure the deflectors 24 to the panels 18 and 20. The deflectors 24 are secured to the panels 18 and 20 above the cutouts 22 to deflect grain away from the cut outs.

In operation, a forced heating system 38 forces air across grain in the pathways 14 through cutouts 22. The cutouts 22 provide a greater airflow across the pathway 14 compared to perforated screens which provides for greater efficiency for drying grain. The cutouts 22 and deflectors 24 keep debris and grain fines from preventing airflow through the pathway 14.

Thus, a panel for a cross flow dryer has been disclosed that improves grain drying efficiency, prevents debris from obstructing airflow, and, at the very least meets all of the stated objectives.

What is claimed is:

1. A screenless panel comprising:
at least one pathway having a plurality of panels with a plurality of cut outs; and
a plurality of deflectors attached to the plurality of panels above the plurality of cuts outs.

2. The screenless panel of claim 1 further comprising the deflectors having a connecting section, a bend line, and a deflecting section.

3. The screenless panel of claim 2 wherein the deflecting section is bent in relation to the connecting section in a thirty degree angle downward.

4. The screenless panel of claim 1 wherein the plurality of cut outs are square.

5. The screenless panel of claim 1 wherein the plurality of panels form at least one pathway.

6. The screenless panel of claim 5 further comprising a grain intake attached to the at least one pathway.

7. The screenless panel of claim 5 further comprising a forced heating system in communication with the pathways such that the forced heating system forces air through the cutout of the pathways and across grain passing through the pathways.

8. The screenless panel of claim 1 further comprising the plurality of panels and the plurality of deflectors having aligned apertures to receive a bolt to secure the deflectors to the panels.
